(19) United States
(12) Patent Application Publication
(10) Pub. No.: US 2026/0050779 A1
(43) Pub. Date: Feb. 19, 2026

(54) METHODS AND APPARATUS TO CONTROL ACTIVATION AND DEACTIVATION IN WIRELESS NETWORKS

(71) Applicant: Intel Corporation, Santa Clara, CA (US)

(72) Inventors: Omid Semiari, Santa Clara, CA (US); Hosein Nikopour, San Jose, CA (US); Lili Wei, Tucson, AZ (US); Wei Mao, Pleasanton, CA (US); Shu-Ping Yeh, San Jose, CA (US)

(73) Assignee: Intel Corporation, Santa Clara, CA (US)

(21) Appl. No.: 19/253,426

(22) Filed: Jun. 27, 2025

Related U.S. Application Data
(60) Provisional application No. 63/786,819, filed on Apr. 10, 2025.

(51) Int. Cl. G06N 3/063; G06N 3/04

(52) U.S. Cl. CPC G06N 3/063; G06N 3/04

(57) ABSTRACT

Systems, apparatus, articles of manufacture, and methods are disclosed control on-off switching in wireless networks. An example computer readable medium comprises instructions that, when executed, cause at least one programmable circuitry to at least generate a mathematical graph that includes measurement information about a first communication cell and a second communication cell; process a first embedding of the mathematical graph with a graph convolutional network layer to generate an updated embedding; concatenate the first embedding and the updated embedding to generate a concatenated embedding; and process the concatenated embedding via a neural network; and cause the first communication cell to be deactivated based on the result of the neural network.

### RELATED APPLICATION

This patent claims the benefit of U.S. Provisional Ser. No. 63/786,819, which was filed on Apr. 10, 2025. U.S. Provisional Ser. No. 63/786,819 is hereby incorporated herein by reference in its entirety. Priority to U.S. Provisional Ser. No. 63/786,819 is hereby claimed.

### BACKGROUND

A cellular communication network is a wireless system that enables mobile devices to communicate with each other and with external networks through a series of interconnected infrastructure components. At its core, the network is divided into cells, each served by a base station equipped with antennas and radio transceivers that manage wireless communication within its coverage area. The Radio Access Network (RAN) is a critical part of this system, providing the wireless connection between user devices and the core network. It handles radio signal processing, resource management, and handovers as devices move between cells. The RAN interfaces with the core network, which manages functions like subscriber authentication, data routing, and interconnection with other networks such as the internet or public switched telephone networks (PSTN), enabling seamless, wide-area mobile communication services.

### BRIEF DESCRIPTION OF THE DRAWINGS

FIG. 1 is a block diagram of an example environment in which an example power control circuitry operates to activate and deactivate cells.

FIG. 2 is a block diagram of an example implementation of the power control circuitry of FIG. 1.

FIGS. 3-4 are flowcharts representative of example machine readable instructions and/or example operations that may be executed, instantiated, and/or performed by example programmable circuitry to implement the power control circuitry 106 of FIG. 2.

FIG. 7 is a block diagram of an example processing platform including programmable circuitry structured to execute, instantiate, and/or perform the example machine readable instructions and/or perform the example operations of FIGS. 3-4 to implement the power control circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Optimizing energy efficiency in Radio Access Networks (RAN) is a fundamental problem that aims at minimizing network operational costs and adhering to stringent environmental regulations, while simultaneously ensuring compliance with service quality within cellular networks. Today, RAN energy cost is a major contributor to network operators' operational expenditures. For a major operator, a reduction in RAN energy can result in large annual savings. A typical cell site in existing wireless networks comprises a relatively large number of cells that are equipped to meet the data demand at peak traffic hours. Each sector offers both low-band carriers (as coverage cells) and mid-band carriers (as capacity booster cells). Such over-provisioned cell deployment systems that put forward service quality over efficiency result in unnecessary energy consumption given that many cells are often under-utilized. This problem will be further exacerbated in future networks that will employ upper mid-band carriers (e.g., planned for 6G) and will rely on further densifications for cell deployment to overcome larger path loss at these higher frequencies.

A technique to reduce RAN energy consumption is to dynamically activate and deactivate frequency carriers (also known as cells) depending on data traffic demand at different regions of the network. As the traffic demand changes over time and space (due to users' mobility and activity), dynamic cell activation and deactivation can present opportunities to completely turn off underloaded carriers/cells and offload their traffic to nearby cells while meeting service requirements of the traffic. On the other hand, non-optimized cell activation decisions can lead to overloading remaining active cells and network performance degradation.

As used herein, deactivation of a component such as a frequency carrier, cell, etc. includes switch the component off, disabling the component, putting the component in a power save state, or any other technique to reduce or eliminate power consumption by the component and/or cause the component to not function during operation of a communication site/network. As used herein, activation of a component such as a frequency carrier, cell, etc. includes switching the component on, enabling the component, putting the component into a higher power state, or any other technique to cause the component to be functional and/or consume additional power during operation.

Methods and apparatus disclosed utilize design principles, including spatial load dependencies of cells, which are missing in the existing solutions. Accounting for interdependent performance across neighboring cells is useful because deactivating a cell mandates moving the traffic load to its nearby neighboring cells. This can lead to overloading nearby cells if they cannot manage the offloaded traffic from the deactivated cell. Such scenarios are particularly important in dense cell deployments with QoS-sensitive traffic. Methods and apparatus disclosed herein capture spatial dependencies and load distribution across cells while making cell activation decisions.

Methods and apparatus disclosed herein utilize an AI-based cell activation/deactivation policy that builds on a Graph Neural Network (GNN) architecture, which may account for spatial traffic load and network resource interdependencies across nearby cells. By using the GNN architecture, a cell activation/deactivation decision can be made not only based on the traffic and resource attributes of a cell, but also based on traffic and resource availability at nearby cells that would be impacted by the cell activation/deactivation decision. The disclosed methods and apparatus can be implemented in highly dense and complex networks, which can optimize energy savings around the clock.

Example methods and apparatus disclosed herein are based on Graph Reinforcement Learning (GRL), a powerful framework at the intersection of GNN and reinforcement learning (RL). In GRL, GNN can serve as the underlying architecture for a deep RL agent's policy or value networks along with modeling of RAN states as graphs. By using GNN, the methods and apparatus may support (a) flexibility to scale to different network sizes regardless of the number of cells, (b) an ability to tackle graph representation tasks for extracting useful (often low-dimensional) embedding for the RAN while capturing RAN graph structure (e.g., user-cell connections), and (c) permutation-invariant processing of graph data (e.g., in aggregating nodes' embeddings), making RAN data processing indifferent to the ordering of cells.

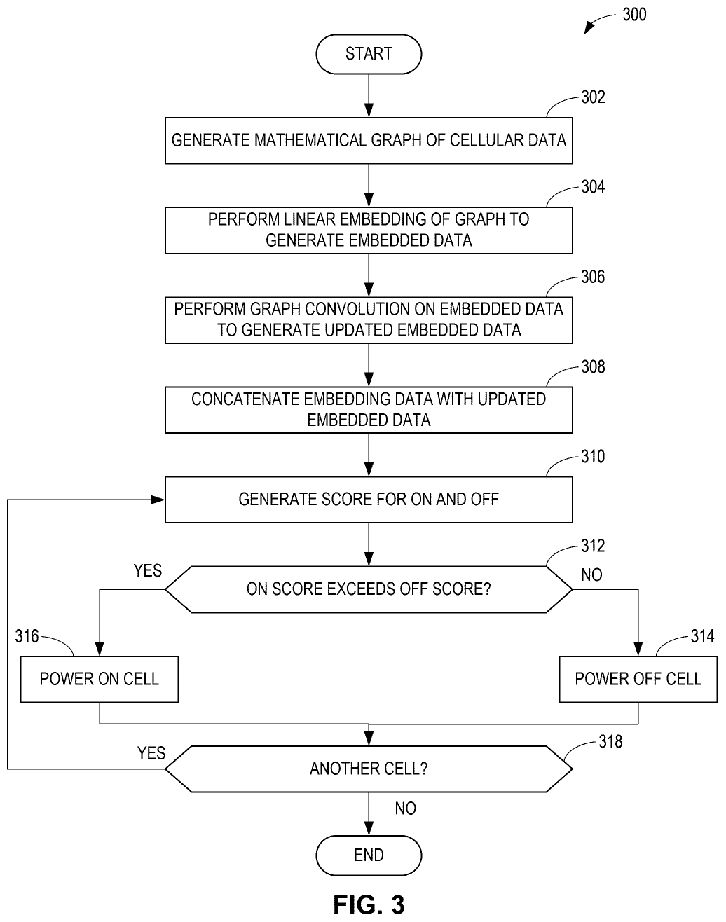

In disclosed methods and apparatus, a GRL-based cell activation/deactivation policy may be trained (e.g., using a deep Q network (DQN) method). The methods and apparatus may utilize a GNN-based architecture for the DQN (e.g., as described in conjunction with FIG. 3). The proposed architecture takes as an input the graph modeling of the RAN environment. RAN can be modeled as a graph with cells representing the graph nodes and graph edges representing communication paths between nearby cells (e.g., fronthaul or backhaul links). The disclosed approach utilizes a set of RAN measurement data (e.g., operational data, utilization data, status information, capacity information, etc.) for each cell including, for example: (1) average bandwidth utilization ratio of the cell, (2) cell status (whether on or off), (3) normalized power consumption, (4) average cell aggregated rate, and (5) number of user equipment (UEs) served. These cell-level measurements may serve as input features to the GNN. Such measurements may be utilized according to current standards (e.g., according to O-RAN E2 Service Mode).

In example methods and apparatus, the input graph (cell-to-cell connectivity along with cell features) is passed through an initial linear embedding layer to transform single-point measurement data to an embedding vector x_{(k,0)} for each cell k. Then, the graph embeddings are passed through a Graph Convolutional Network (GCN) layer, allowing each cell to integrate the information of its neighboring cells into its own embeddings. This information aggregation seamlessly allows the cell activation/deactivation agent to account for spatial dependencies (both traffic load and network resources) across the cells. The output of the GCN layer is still a graph, but node (cell) embeddings now represent spatial dependencies. Let x_{(k,1)} be the embedding vector of cell node k post GCN layer. To preserve the original data of the cell, a concatenation layer may be utilized to concatenate for each node k its initial embedding x_{(k,0)} with the updated embedding x_{(k,1)} as a final embedding vector x_{(k,2)}. Lastly, for each candidate cell to potentially deactivate, the methods and apparatus may pass x_{(k,2)} into a two-layer fully connected network with an output size of two. The two outputs of the layer correspond to Q values associated with actions that determine whether to deactivate a cell or leave it as on.

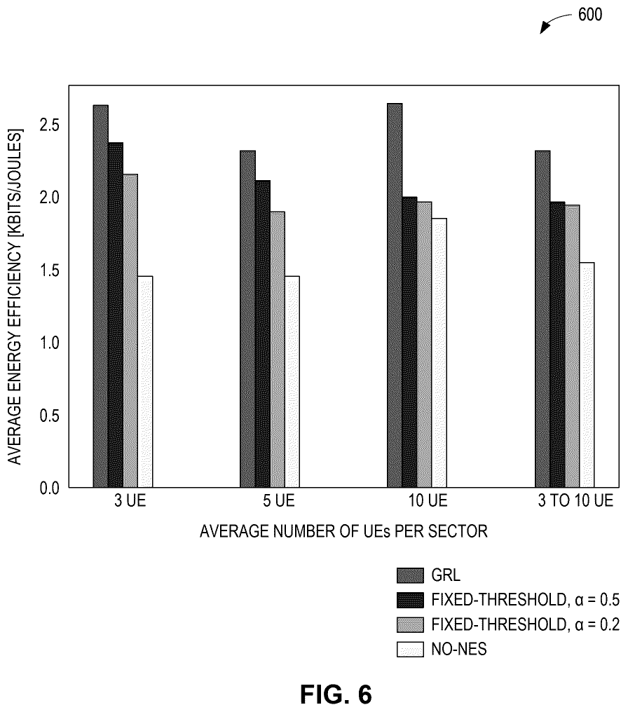

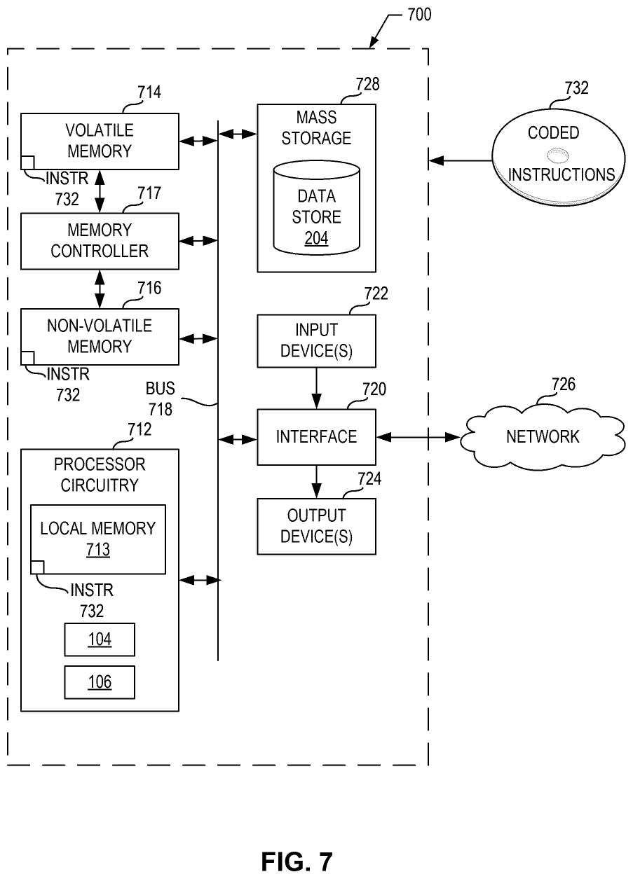

In some examples, the cell activation/deactivation problem can be treated as a Markov Decision Process (MDP) where the agent may be implemented as an rApp (e.g., as described in conjunction with FIG. 7) that learns an optimized cell activation/deactivation policy through iterative interaction with the RAN.

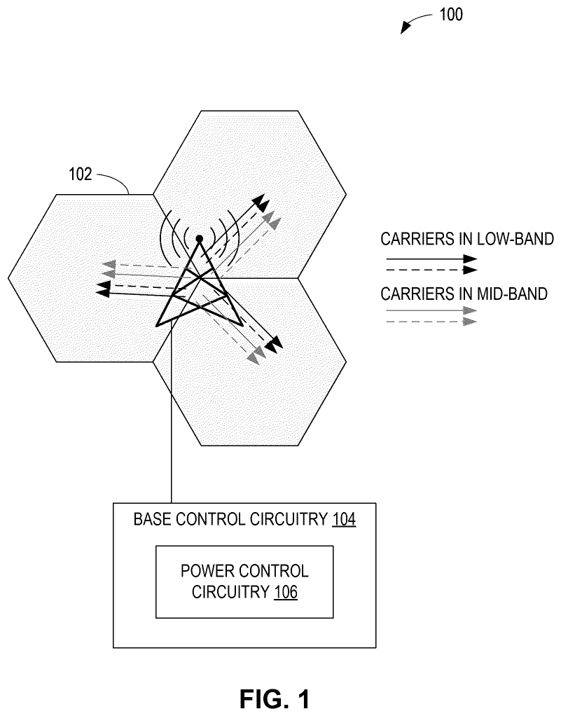

FIG. 1 is a block diagram of an example environment 100 in which an example power control circuitry 106 operates to control activation/deactivation of cells. The example environment 100 includes an example mobile carrier site 102 and a base control circuitry 104. The example environment 100 is a simplified environment as persons of ordinary skill in the art are familiar with the different components and implementations of cellular communication networks.

The example carrier site 102 is a multi-band multi-carrier site deployment. Each sector of the carrier site 102 offers both low-band carriers (as coverage cells) and mid-band carriers (as capacity booster cells). Alternatively, the carrier site 102 may include any combination of carriers. Furthermore, while a single carrier site 102 is shown for illustration, a mobile communication environment may include a plurality of carrier sites serving a plurality of cells.

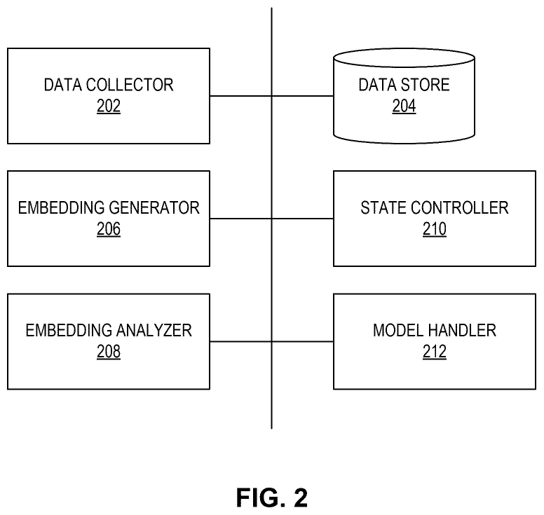

The example base control circuitry 104 is a RAN intelligent controller (RIC) to control the operation of the carrier site 102. The example base control circuitry 104 includes example power control circuitry 106 to control activation/deactivation of cells of the carrier site 102 and/or other carrier sites that may be present in the environment. The example power control circuitry 106 utilizes graph reinforcement learning based on mathematical graph data that incorporates information about neighboring cells to facilitate activation/deactivation of cells for power efficiency. Alternatively, any other type of machine learning may be utilized to determine activation/deactivation of cells based on data (e.g., capacity data, load data, power requirements, etc.) about neighboring cells. While the example base control circuitry 104 is implemented by an RIC, any other combinations and/or types of hardware, software, circuitry, etc. (e.g., a radio access network controller) that can analyze data regarding neighboring cells and direct on/off control may be utilized. An example implementation of the power control circuitry 106 is described in conjunction with FIG. 2.

FIG. 2 is a block diagram of an example implementation of the power control circuitry 106 of FIG. 1 to control activation/deactivation of cells (e.g., for power reduction). The power control circuitry 106 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the power control circuitry 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example implementation of the power control circuitry 106 illustrated in FIG. 2 includes data collector circuitry 202, a data store 204, embedding generator circuitry 206, embedding analyzer circuitry 208, state controller circuitry 210, and model handler circuitry 212.

The data collector circuitry 202 collects operational data from a mobile communication systems. According to the illustrated example, the data collector circuitry 202 collects information about the operation of cells in an area (e.g., neighboring cells). For example, the data may include traffic levels of each cell, number of devices connected to each cell, capacity of each cell, distance between cells, average bandwidth utilization ratio of each cell, a cell status of each cell (e.g., whether on or off), normalized power consumption of each cell, average cell aggregated rate, etc. The data collector circuitry 202 may receive information collected by other devices/sensors, may query the cells for the information, may monitor the cells to collect the information, etc. The example data collector circuitry 202 formats the collected data as a mathematical graph. For example, the data collector circuitry 202 may model the data as a graph with cells representing the graph nodes and graph edges representing communication paths between nearby cells (e.g., fronthaul or backhaul links). The data collector circuitry 202 stores the collected information in the example data store 204.

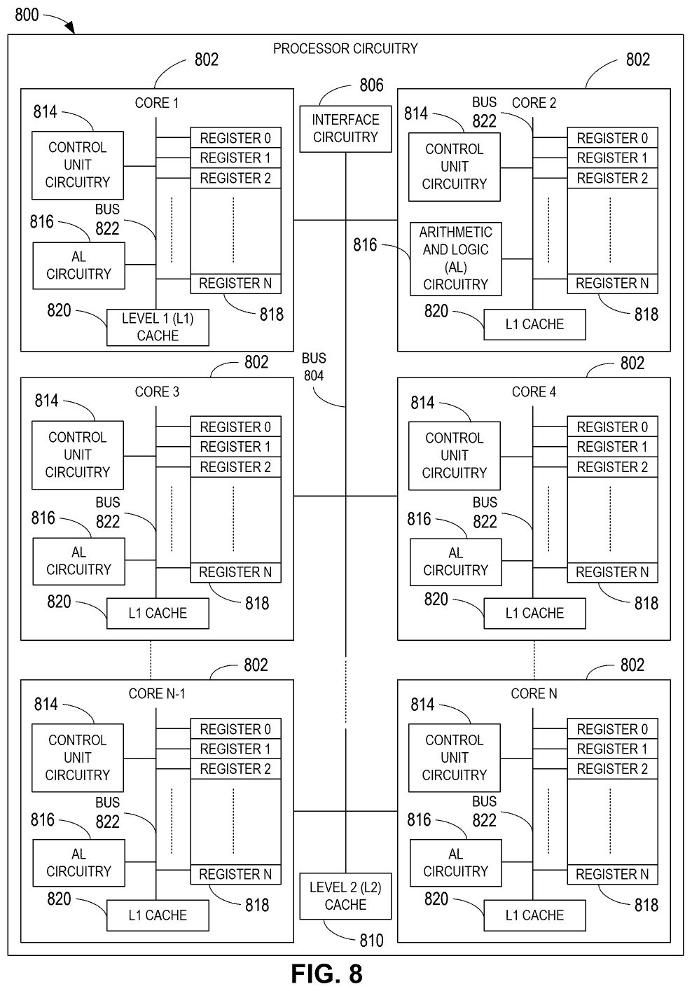

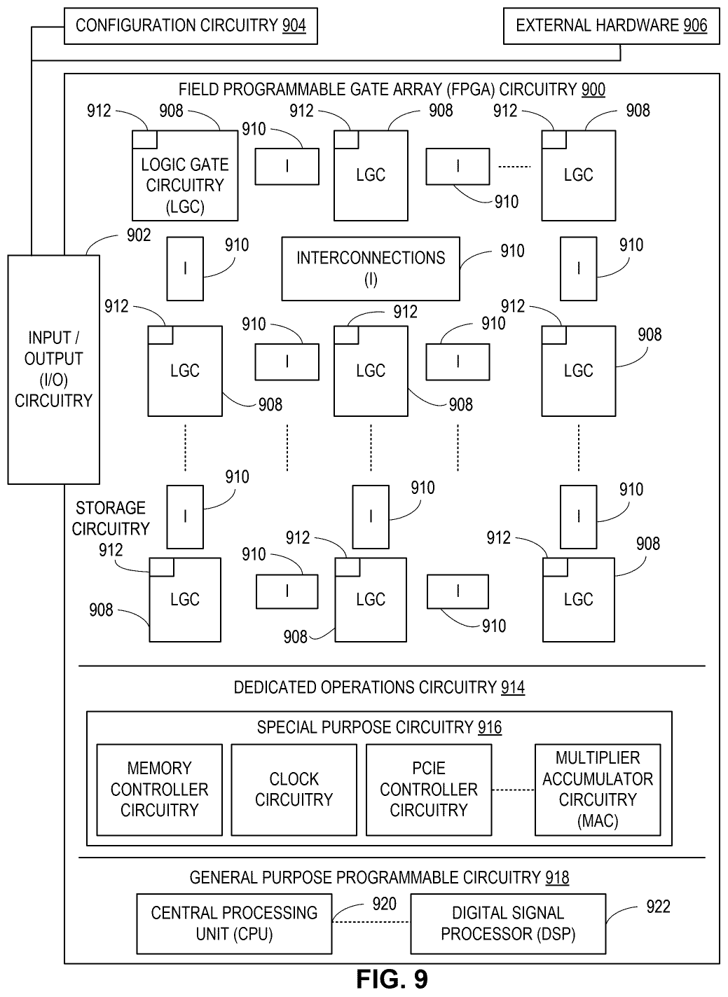

In some examples, the power control circuitry 106 includes means collecting data. For example, the means for collecting data may be implemented by data collector circuitry 202. In some examples, the data collector circuitry 202 may be instantiated by programmable circuitry such as the example programmable circuitry 712 of FIG. 7. For instance, the data collector circuitry 202 may be instantiated by the example microprocessor 800 of FIG. 8 executing machine executable instructions such as those implemented by at least block 302 of FIG. 3. In some examples, the data collector circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the data collector circuitry 202 may be instantiated by any other combination of hardware, software, and/or firmware. For example, the data collector circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example data store 204 is a database to store cell analytics data and machine learning models. Alternatively, the data store 204 may be any type and number of storage such as files, random access memory, disk storage, flash storage, etc.

The example embedding generator circuitry 206 perform linear embedding of the graph data from the data collector circuitry 206 to transform single-point measurement data to an embedding vector for each cell. While the example embedding generator circuitry 206 utilizes linear embedding, the embedding generator circuitry 206 may utilize any type of data embedding to prepare the collected data for analysis (e.g., to generate vectors for the data).

In some examples, the power control circuitry 106 includes means embedding. For example, the means for embedding may be implemented by embedding generator circuitry 206. In some examples, the embedding generator circuitry 206 may be instantiated by programmable circuitry such as the example programmable circuitry 712 of FIG. 7. For instance, the embedding generator circuitry 206 may be instantiated by the example microprocessor 800 of FIG. 8 executing machine executable instructions such as those implemented by at least block 304 of FIG. 3. In some examples, the embedding generator circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the embedding generator circuitry 206 may be instantiated by any other combination of hardware, software, and/or firmware. For example, the embedding generator circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example embedding analyzer circuitry 208 analyzes the embedded graph data to determine in a recommended state (e.g., on or off) for each cell. The example embedding analyzer circuitry 208 passes the embedded graph data through a Graph Convolutional Network (GCN) layer, allowing each cell to integrate the information of its neighboring cells into its own embeddings. For example, the information aggregation may allow the power control circuitry 106 to account for spatial dependencies (both traffic load and network resources) across the cells. The output of the GCN layer is still a graph, but node (cell) embeddings now represent spatial dependencies. Let x_{k,1} be the embedding vector of cell node k post GCN layer. To preserve the original data of the cell, the example embedding analyzer circuitry 208 concatenates for each node k its initial embedding x_{k,0} with the updated embedding x_{k,1} as a final embedding vector x_{k,2}. Then, the example embedding analyzer circuitry 208, for each candidate cell, utilizes a a two-layer fully connected network with an output size of two. The two outputs correspond to Q values associated with actions that determine whether to deactivate a cell or leave it as on.

While the foregoing describes a particular implementation of the data embedding analyzer circuitry 208, other approaches for analyzing the embedded data may be utilized.

In some examples, the power control circuitry 106 includes means embedding analysis. For example, the means for embedding analysis may be implemented by embedding analyzer circuitry 208. In some examples, the data embedding analyzer circuitry 208 may be instantiated by programmable circuitry such as the example programmable circuitry 712 of FIG. 7. For instance, the data embedding analyzer circuitry 208 may be instantiated by the example microprocessor 800 of FIG. 8 executing machine executable instructions such as those implemented by at least blocks 306-310 of FIG. 3. In some examples, the data embedding analyzer circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the data embedding analyzer circuitry 208 may be instantiated by any other combination of hardware, software, and/or firmware. For example, the data embedding analyzer circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example state controller circuitry 210 controls the state of cells based on the decisions made by the embedding analyzer circuitry 208. For example, the state controller circuitry 210 may instruct a base station to power on or off one or more cells. The example state controller circuitry 210 may have direct or indirect control over cell states.

In some examples, the power control circuitry 106 includes means state control. For example, the means for state control may be implemented by state controller circuitry 210. In some examples, the state controller circuitry 210 may be instantiated by programmable circuitry such as the example programmable circuitry 712 of FIG. 7. For instance, the state controller circuitry 210 may be instantiated by the example microprocessor 800 of FIG. 8 executing machine executable instructions such as those implemented by at least blocks 312-316 of FIG. 3. In some examples, the state controller circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the state controller circuitry 210 may be instantiated by any other combination of hardware, software, and/or firmware. For example, the state controller circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example model handler circuitry 212 performs training of the machine learning system (e.g., graph neural network) of the power control circuitry 106. For example, the model controller circuitry 212 may cause state changes to a real or virtual environment and determine the resulting environment results (e.g., power usage, user experience, etc.) to provide reinforcement learning (e.g., to reinforce low power, preferred user experience, etc.). The model controller circuitry 212 may artificially causes state changes to determine the results and/or may operate in an environment in which state changes will occur. The example model handler circuitry 212 stores learning model parameters in the data store 204. While the model handler circuitry 212 is included as part of the power control circuitry 106, the model handler circuitry 212 may be implemented as a separate and/or standalone device (e.g., implemented at a server of a manufacturer that distributes model information.

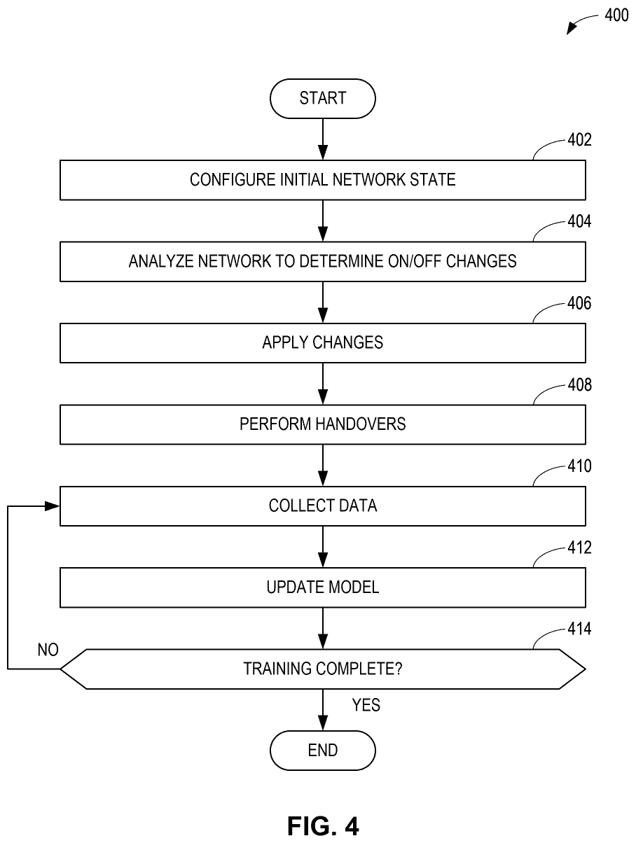

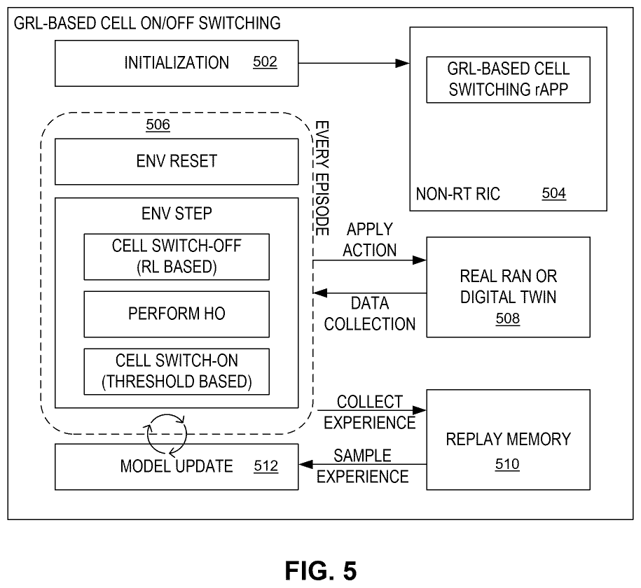

In some examples, the power control circuitry 106 includes means handling models. For example, the means for handling models may be implemented by model handler circuitry 212. In some examples, the model handler circuitry 212 may be instantiated by programmable circuitry such as the example programmable circuitry 712 of FIG. 7. For instance, the model handler circuitry 212 may be instantiated by the example microprocessor 800 of FIG. 8 executing machine executable instructions such as those implemented by at least blocks 402-414 of FIG. 4. In some examples, the model handler circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the model handler circuitry 212 may be instantiated by any other combination of hardware, software, and/or firmware. For example, the model handler circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the power control circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the data collector circuitry 202, the example embedding generator circuitry 206, the example embedding analyzer circuitry 208, and the example model handler circuitry 212, and/or, more generally, the example power control circuitry 106 of FIG. 2, may be implemented by hardware alone or by hardware in combination with software and/or firmware. Thus, for example, any of the data collector circuitry 202, the example embedding generator circuitry 206, the example embedding analyzer circuitry 208, and the example model handler circuitry 212, and/or, more generally, the example power control circuitry 106, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example power control circuitry 106 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the power control circuitry 106 of FIG. 2 and/or representative of example operations which may be performed by programmable circuitry to implement and/or instantiate the power control circuitry 106 of FIG. 2, are shown in FIGS. 3-4. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-4, many other methods of implementing the example power control circuitry 106 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to analyze cell operational data including data for neighboring cells to determine cells to turn on and off to balance user performance and power efficiency. The example machine-readable instructions and/or the example operations 300 of FIG. 3 begin at block 302, at which the data collector circuitry 202 gathers operational data and generates a mathematical graph of the cellular data (block 302). The example embedding generator circuitry 206 performs linear embedding of the graph data to generated embedded graph data (block 304).

Then, the embedding analyzer circuitry 206 performs graph convolution on the embedded data to generate updated embedded data (block 306). For example, the convolution may be performed with a Graph Convolutional Network (GCN) Layer to allow each cell to integrate the information of its neighboring cell into its own embeddings. The output of the GCN layer is still a graph, but node (cell) embeddings are now representing spatial dependencies. The embedding analyzer circuitry 206 concatenates the original embedded data (e.g., from block 304) with the updated embedded data (e.g., the result of block 306) to preserve the original data of the cell (block 308). For example, let x_{k,1} be the embedding vector of cell node k after the GCN layer, the concatenation layer concatenates for each node k its initial embedding x_{k,0} with the updated embedding x_{k,1} as a final embedding vector x_{k,2}.

The embedding analyzer circuitry 208 then generates a score for “on” and a score for “off” (block 310). The example embedding analyzer circuitry 208, for each candidate cell to control, passes x_{k,2} into a two-layer fully connected network with an output size of two. The two outputs correspond to Q values associated with actions that determine whether to deactivate a cell or leave it activated. The state controller circuitry 210 determines if the if the “on” score exceeds the “off” score (block 312). When the “on” score does not exceed the “off” score, the state controller circuitry 210 powers the cell off (or leaves the cell powered off) (block 314). When the “on” score exceeds the “off” score, the state controller circuitry 210 powers the cell on (or leaves the cell powered on) (block 316). After the state controller circuitry 210 controls the state of a cell, the data collector circuitry 202 determines if there is another cell to be analyzed (block 318) and, if so, control returns to block 310 to determine a state control for the next cell.

FIG. 4 is a flowchart representative of example machine readable instructions and/or example operations 400 that may be executed, instantiated, and/or performed by programmable circuitry to train a machine learning model on cell state control based on neighbor cell information. The example machine-readable instructions and/or the example operations 400 of FIG. 4 begin at block 402, at which the state controller circuitry 210 controls an initial network state (block 402). For example, the state controller circuitry 210 may set cells to an initial on/off state (e.g., all cells on, all cells off, cells randomly controlled, cells set according to user preferences, etc.). The network may be a real or virtual/simulated network and the network may be operational or in a testing environment.

The data collector circuitry 202, embedding generator circuitry 206, and the embedding analyzer circuitry 208 analyze the cells to determine on/off changes for the cells of the network (block 404). The changes could be based on the network operational parameters (e.g., as described in conjunction with FIG. 3), the changes could be randomized changes, the changes could be changes according to a testing/training procedures, etc. The state controller circuitry 210 applies the changes by turning cells on or off accordingly (block 406). The state controller circuitry 210 also causes any user equipment connected to a cell to be powered off to be handed over to a neighboring cell (block 408).

The data collector circuitry 202 then collects data about the environment after the change(s) (block 410). For example, the data may include network and/or device bandwidth, power usage, user experience information, etc. Based on the user experience information, the model handler circuitry 212 updates the machine learning model for the environment (block 412). For example, the model handler circuitry 212 may have factory and/or user settings for rewards to be increased and/or penalties to be minimized (e.g., maximize user experience and minimize power usage). The model handler circuitry 212 determines if training is complete (e.g., has data from all cells been utilized for training) (block 414). If all model training is not complete, control returns to block 410 for further training.

FIG. 5 is an illustration of the power control circuitry implemented as an rApp 500 that solves the activation/deactivation problem as a Markov Decision Process (MDP). The example rApp 500 performs initialization of a mobile environment (block 502). The initialization may include setting the state of cells. The rApp 500 includes a non-realtime RIC to perform graph reinforcement learning for cell activation/deactivation. The rApp 500 performs environment control in block 506. The example environment control includes possibly resetting the state of an environment (e.g., to reset an activation/deactivation state of cells), performing cell deactivation (e.g., based on reinforcement learning decisions), handing over any devices attached to cells that are deactivated, and activating cells based on decision thresholds. The actions decided in block 506 are applied to a real RAN and/or a digital twin represented by block 508). Data is collected about the resulting environment and the user experience is recorded in a replay memory 510. The model for the graph reinforcement learning is then updated based on the user experience (e.g., to reinforce state decisions that increase experience and decrease power usage in light of cooperation among neighboring cells).

FIG. 6 is a graph 600 illustrating example results for applying the proposed GRL approach to cell on/off control to a small-scale network scenario with three cell sites, each comprising three cells (one serving as a coverage carrier and two as capacity booster cells). In the graph 600, the GRL method is compared with threshold-based policies that deactivates a cell only if its bandwidth utilization ratio is below a a threshold. The results show that the GRL-based policy can improve network energy efficiency by 30%.

FIG. 7 is a block diagram of an example programmable circuitry platform 700 structured to execute and/or instantiate the example machine-readable instructions and/or the example operations of FIGS. 3-4 to implement the power control circuitry 106 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the base control circuitry 104 including the power control circuitry 106.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 3-4, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3-4 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-4.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 3-4 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-4. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-4. As such, the FPGA circuitry 900 may be configured and/or structured to effectively instantiate some or all of the operations/functions corresponding to the machine readable instructions of the flowchart(s) of FIGS. 3-4 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 3-4 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 3-4 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 9. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 3-4 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 3-4, and/or an ASIC may be configured and/or structured to perform third operation(s)/function(s) corresponding to a third portion of the machine readable instructions represented by the flowcharts of FIGS. 3-4.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

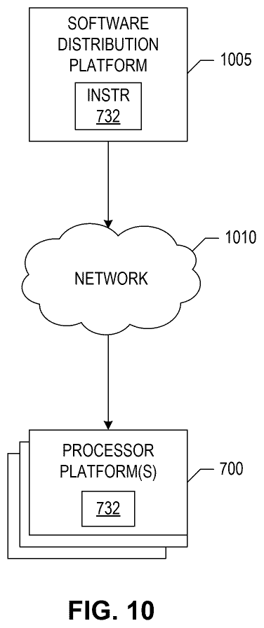

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3-4, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 3-4, may be downloaded to the example programmable circuitry platform 700, which is to execute the machine readable instructions 732 to implement the power control circuitry 106. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software”could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time”refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that control the on/off of cells based on consideration of measurement information of the cells and neighboring cells. Disclosed systems, apparatus, articles of manufacture, and methods improve the efficiency of using a computing device by increasing power efficiency through the turning off of cells based on consideration of measurement information of the cells and neighboring cells (e.g., to avoid overloading neighboring cells when powering off a cell or underutilizing neighboring cells by keeping a cell powered on). Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to methods and apparatus to control on activation and deactivation in wireless networks are disclosed herein. Further examples and combinations thereof include the following:

Example 1 includes at least one computer readable medium comprising instructions that, when executed, cause at least one programmable circuitry to at least generate a mathematical graph that includes measurement information about a first communication cell and a second communication cell, process a first embedding of the mathematical graph with a graph convolutional network layer to generate an updated embedding, concatenate the first embedding and the updated embedding to generate a concatenated embedding, and process the concatenated embedding via a neural network, and cause the first communication cell to be deactivated based on a result of the neural network.

Example 2 includes the at least one computer readable medium of example 1, wherein the neural network is a two-layer neural network.

Example 3 includes the at least one computer readable medium of one of examples 1-2, wherein the measurement information includes at least one of bandwidth utilization information, cell status, power consumption information, aggregate data rate, and number of devices served by a cell.

Example 4 includes the at least one computer readable medium of one of examples 1-3, wherein the instructions, when executed, cause the at least one programmable circuitry to perform linear embedding of the mathematical graph.

Example 5 includes the at least one computer readable medium of one of examples 1-4, wherein the instructions, when executed, cause the at least one programmable circuitry to determine, based on the neural network, a first score for activation of the first communication cell, determine, based on the neural network, a second score for deactivation of the first communication cell, and cause the first communication cell to be deactivated when the second score exceeds the first score.

Example 6 includes the at least one computer readable medium of one of examples 1-5, wherein the first communication cell is part of a radio access network.

Example 7 includes the at least one computer readable medium of one of examples 1-6, wherein the first communication cell and the second communication cell are communication neighbors.

Example 8 includes an apparatus comprising data collection circuitry to obtain measurement information about a first communication cell and a second communication cell, instructions, at least one programmable circuitry to execute or implement the instructions to at least generate a mathematical graph that includes the measurement information, process a first embedding of the mathematical graph with a graph convolutional network layer to generate an updated embedding, concatenate the first embedding and the updated embedding to generate a concatenated embedding, and process the concatenated embedding via a neural network, and cause the first communication cell to be deactivated based on a result of the neural network.

Example 9 includes the apparatus of example 8, wherein the neural network is a two-layer neural network.

Example 10 includes the apparatus of one of examples 8-9, wherein the measurement information includes at least one of bandwidth utilization information, cell status, power consumption information, aggregate data rate, and number of devices served by a cell.

Example 11 includes the apparatus of one of examples 8-10, wherein the at least one programmable circuitry is to perform linear embedding of the mathematical graph.

Example 12 includes the apparatus of one of examples 8-11, wherein the at least one programmable circuitry is to determine, based on the neural network, a first score for activation of the first communication cell, determine, based on the neural network, a second score for deactivation of the first communication cell, and cause the first communication cell to be deactivated when the second score exceeds the first score.

Example 13 includes the apparatus of one of examples 8-12, wherein the first communication cell is part of a radio access network.

Example 14 includes the apparatus of one of examples 8-13, wherein the first communication cell and the second communication cell are communication neighbors.

Example 15 includes a system comprising a multi-band communication site including a first communication cell and a second communication cell, a radio access network controller to generate a mathematical graph that includes measurement information about the first communication cell and the second communication cell, process a first embedding of the mathematical graph with a graph convolutional network layer to generate an updated embedding, concatenate the first embedding and the updated embedding to generate a concatenated embedding, and process the concatenated embedding via a neural network, and cause the first communication cell to be deactivated based on a result of the neural network.

Example 16 includes the system of example 15, wherein the neural network is a two-layer neural network.

Example 17 includes the system of one of examples 15-16, wherein the measurement information includes at least one of bandwidth utilization information, cell status, power consumption information, aggregate data rate, and number of devices served by a cell.

Example 18 includes the system of one of examples 15-17, wherein the radio access network controller is to perform linear embedding of the mathematical graph.

Example 19 includes the system of one of examples 15-18, wherein the radio access network controller is to determine, based on the neural network, a first score for activation of the first communication cell, determine, based on the neural network, a second score for deactivation of the first communication cell, and cause the first communication cell to be deactivated when the second score exceeds the first score.

Example 20 includes the system of one of examples 15-19, wherein the first communication cell and the second communication cell are communication neighbors.

Example 21 includes a method comprising generating a mathematical graph that includes measurement information about a first communication cell and a second communication cell, processing a first embedding of the mathematical graph with a graph convolutional network layer to generate an updated embedding, concatenating the first embedding and the updated embedding to generate a concatenated embedding, and processing the concatenated embedding via a neural network, and causing the first communication cell to be deactivated based on a result of the neural network.

Example 22 includes the method of example 21, wherein the neural network is a two-layer neural network.

Example 23 includes the method of one of examples 21-22, wherein the measurement information includes at least one of bandwidth utilization information, cell status, power consumption information, aggregate data rate, and number of devices served by a cell.

Example 24 includes the method of one of examples 21-23, further comprising performing linear embedding of the mathematical graph.

Example 25 includes the method of one of examples 21-24, further comprising determining, based on the neural network, a first score for activation of the first communication cell, determining, based on the neural network, a second score for deactivation of the first communication cell, and causing the first communication cell to be deactivated when the second score exceeds the first score.

Example 26 includes the method of one of examples 21-25, wherein the first communication cell is part of a radio access network.

Example 27 includes the method of one of examples 21-26, wherein the first communication cell and the second communication cell are communication neighbors.

Example 28 includes an apparatus to perform the method of any of examples 21-27

Example 29 includes a method to be performed by an apparatus executing the instructions of any one of examples 1-14.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory computer readable medium comprising instructions that, when executed, cause at least one programmable circuitry to at least:
generate a mathematical graph that includes measurement information about a first communication cell and a second communication cell;
process a first embedding of the mathematical graph with a graph convolutional network layer to generate an updated embedding;
concatenate the first embedding and the updated embedding to generate a concatenated embedding;
process the concatenated embedding via a neural network; and
cause the first communication cell to be deactivated based on a result of the neural network.

2. The at least one non-transitory computer readable medium of claim 1, wherein the neural network is a two-layer neural network.

3. The at least one computer readable medium of claim 1, wherein the measurement information includes at least one of bandwidth utilization information, cell status, power consumption information, aggregate data rate, and number of devices served by a cell.

4. The at least one non-transitory computer readable medium of claim 1, wherein the instructions, when executed, cause the at least one programmable circuitry to perform linear embedding of the mathematical graph.

5. The at least one non-transitory computer readable medium of claim 1, wherein the instructions, when executed, cause the at least one programmable circuitry to:
determine, based on the neural network, a first score for activation of the first communication cell;
determine, based on the neural network, a second score for deactivation of the first communication cell; and
cause the first communication cell to be deactivated when the second score exceeds the first score.

6. The at least one non-transitory computer readable medium of claim 1, wherein the first communication cell is part of a radio access network.

7. The at least one non-transitory computer readable medium of claim 1, wherein the first communication cell and the second communication cell are communication neighbors.

8. An apparatus comprising:
data collection circuitry to obtain measurement information about a first communication cell and a second communication cell;
instructions;
at least one programmable circuitry to execute or implement the instructions to at least:
generate a mathematical graph that includes the measurement information;
process a first embedding of the mathematical graph with a graph convolutional network layer to generate an updated embedding;
concatenate the first embedding and the updated embedding to generate a concatenated embedding; and
process the concatenated embedding via a neural network; and
cause the first communication cell to be deactivated based on a result of the neural network.

9. The apparatus of claim 8, wherein the neural network is a two-layer neural network.

10. The apparatus of claim 8, wherein the measurement information includes at least one of bandwidth utilization information, cell status, power consumption information, aggregate data rate, and number of devices served by a cell.

11. The apparatus of claim 8, wherein the at least one programmable circuitry is to perform linear embedding of the mathematical graph.

12. The apparatus of claim 8, wherein the at least one programmable circuitry is to:
determine, based on the neural network, a first score for activation of the first communication cell;
determine, based on the neural network, a second score for deactivation of the first communication cell; and
cause the first communication cell to be deactivated when the second score exceeds the first score.

13. The apparatus of claim 8, wherein the first communication cell is part of a radio access network.

14. The apparatus of claim 8, wherein the first communication cell and the second communication cell are communication neighbors.

15. A system comprising:
a multi-band communication site including a first communication cell and a second communication cell;
a radio access network controller to:
generate a mathematical graph that includes measurement information about the first communication cell and the second communication cell;
process a first embedding of the mathematical graph with a graph convolutional network layer to generate an updated embedding;
concatenate the first embedding and the updated embedding to generate a concatenated embedding; and
process the concatenated embedding via a neural network; and
cause the first communication cell to be deactivated based on a result of the neural network.

16. The system of claim 15, wherein the neural network is a two-layer neural network.

17. The system of claim 15, wherein the measurement information includes at least one of bandwidth utilization information, cell status, power consumption information, aggregate data rate, and number of devices served by a cell.

18. The system of claim 15, wherein the radio access network controller is to perform linear embedding of the mathematical graph.

19. The system of claim 15, wherein the radio access network controller is to:
determine, based on the neural network, a first score for activation of the first communication cell;
determine, based on the neural network, a second score for deactivation of the first communication cell; and
cause the first communication cell to be deactivated when the second score exceeds the first score.

20. The system of claim 15, wherein the first communication cell and the second communication cell are communication neighbors.
